(19) United States
(12) Patent Application Publication
(10) Pub. No.: US 2014/0122328 A1
(43) Pub. Date: May 1, 2014

(54) MOBILE DEVICE FOR MULTIPLE PAYMENT MODES

(71) Applicant: BANK OF AMERICA CORPORATION, Charlotte, NC (US)

(72) Inventor: David M. Grigg, Rock Hill, SC (US)

(73) Assignee: Bank of America Corporation, Charlotte, NC (US)

(21) Appl. No.: 13/667,580

(22) Filed: Nov. 2, 2012

Related U.S. Application Data
(60) Provisional application No. 61/719,548, filed on Oct. 29, 2012.

(51) Int. Cl. G06Q 20/32; G06Q 20/14

(52) U.S. Cl. 705/40; 705/39

(57) ABSTRACT

Embodiments of the invention are directed to making a payment using a portable mobile communication apparatus. An exemplary portable mobile communication apparatus is configured to: initiate presentation of a first option on a user interface to pay via readable indicia (e.g., a QR code), initiate presentation of a second option on the user interface (e.g., the same user interface) to pay via a short-range wireless mechanism (e.g., NFC), and determine a payment option selected by a user.

### CROSS-REFERENCE TO RELATED APPLICATIONS

This application claims priority to U.S. Provisional Patent Application Ser. No. 61/719,548, filed Oct. 29, 2012, entitled “Mobile Device For Multiple Payment Modes,” the entirety which is incorporated herein by reference.

### BACKGROUND

There is a need to enable a user of a mobile device to quickly and efficiently access various payment modes for making a payment using a mobile device.

### BRIEF SUMMARY

Embodiments of the invention are directed to systems, methods and computer program products for making a payment. An exemplary portable mobile communication apparatus is configured to: initiate presentation of a first option on a user interface to pay via readable indicia; initiate presentation of a second option on the user interface to pay via a short-range wireless mechanism; and determine a payment option selected by a user.

In some embodiments, in response to determining the first option is selected by the user, the module is configured to enable selection of a payment card from a list of payment cards presented on the user interface or automatically select a default payment card.

In some embodiments, in response to determining the first option is selected, the module is configured to activate a transceiver for communicating information associated with a selected payment card.

In some embodiments, a transceiver for making a payment via the short-range wireless mechanism is an active transceiver or a passive transceiver, wherein information associated with one or more payment cards is stored in a secure module in the mobile device or at a remote server accessible by the mobile device.

In some embodiments, the short-range wireless mechanism comprises near-field communication (NFC).

In some embodiments, the apparatus comprises an image-capturing component, wherein in response to determining the second option is selected, the module is configured to activate the image-capturing component to capture an image of the readable indicia, wherein the readable indicia comprises at least one of electronic readable indicia or physical readable indicia.

In some embodiments, the module is further configured to process the readable indicia, wherein processing the readable indicia comprises at least one of initiating presentation of a user interface that prompts the user to select a payment card, or automatically selecting a default payment card.

In some embodiments, in response to determining the second option is selected, the module is configured to generate readable indicia on the user interface, wherein a receiving terminal captures an image of the readable indicia and initiates processing of the readable indicia, wherein processing the readable indicia enables determination of a payment card associated with the user.

In some embodiments, the generated readable indicia is based on an identity of a recipient associated with the receiving terminal, wherein the identity of the recipient is specified by the user or automatically determined by the module based on location information associated with the mobile device.

In some embodiments, the readable indicia comprises a Quick Response (QR) code.

In some embodiments, the module is further configured to initiate presentation of a third option on the user interface to pay via alias. A payment via alias may also be referred to as a peer-to-peer (P2P) payment.

In some embodiments, in response to determining the third option is selected, the module is configured to enable the user to input a payment amount and an alias associated with a payment recipient, wherein the alias comprises at least one of a phone number, email address, social networking account information, or financial institution account information.

In some embodiments, the module is further configured to initiate presentation of a fourth option on the user interface to pay via a network.

In some embodiments, the module is further configured to initiate presentation of a fifth option on the user interface to make a bill payment.

In some embodiments, in response to determining the fifth option is selected, the module enables selection of a bill associated with the user's account, and at least one of a payment card associated with the account, a payment date on which the bill payment will be made, or an amount of the bill payment on the selected payment date.

In some embodiments, the first option and the second option are accessible via the user's account, wherein the account comprises at least one of a financial institution account, a merchant account, a social networking account, or a mobile payment account.

In some embodiments, receipts associated with executed payments are stored in the apparatus or stored at an external server, wherein the receipts comprise a first receipt associated with a payment made via the readable indicia and a second receipt associated with a payment made via the short-range wireless mechanism.

In some embodiments, the module, based on location information associated with the mobile device, initiates presentation on the user interface of a payment option available to the user, and wherein the module does not initiate presentation on the user interface of a payment option unavailable to the user.

In some embodiments, the module, based on location information associated with the apparatus, initiates presentation on the user interface of a payment option available to the user, and wherein the module does not initiate presentation on the user interface of a payment option unavailable to the user, wherein a payment option available to the user comprises a payment option accepted by a merchant corresponding to the location information associated with the apparatus.

In some embodiments, the module, based on location information associated with the apparatus, initiates presentation on the user interface of a payment option available to the user, and wherein the module initiates presentation on the user interface of a payment option unavailable to the user, wherein the module does not enable the user to select the payment option unavailable to the user, wherein a payment option available to the user comprises a payment option accepted by a merchant corresponding to the location information associated with the apparatus.

In some embodiments, the module is configured to initiate a default payment option on the user interface, wherein the default payment option comprises a payment option based on a payment history associated with the user, wherein the payment history is associated with at least one transaction executed by the user associated with a merchant corresponding to location information associated with the apparatus.

In some embodiments, the module is configured to initiate a default payment option on the user interface, wherein the default payment option comprises a payment option selected by the user on a previous occasion when the user executed a transaction associated with a merchant corresponding to location information associated with the apparatus, or wherein the default payment option comprises a payment option most frequently selected by the user during a predetermined period of time when the user executed at least one transaction associated with a merchant corresponding to location information associated with the apparatus, and wherein the module enables the user to select a payment option different from the default payment option.

In some embodiments, a method is provided for making a payment using a portable mobile communication apparatus. The method comprises: initiating presentation of a first option on a user interface to pay via readable indicia; initiating presentation of a second option on the user interface to pay via a short-range wireless mechanism; and determining a payment option selected by a user.

In some embodiments, a computer program product is provided for making a payment using a portable mobile communication apparatus. The computer program product comprises a non-transitory computer-readable medium comprising a set of codes for causing a portable mobile communication apparatus to: initiate presentation of a first option on a user interface to pay via readable indicia; initiate presentation of a second option on the user interface to pay via a short-range wireless mechanism; and determine a payment option selected by a user.

### BRIEF DESCRIPTION OF THE DRAWINGS

Having thus described embodiments of the invention in general terms, reference will now be made to the accompanying drawings, where:

FIG. 1 is a flowchart illustrating a general process flow for making a payment, in accordance with embodiments of the present invention; and

FIG. 2 is a block diagram illustrating technical components of a system for making a payment, in accordance with embodiments of the present invention; and

FIGS. 3-10 are exemplary user interfaces associated with making a payment, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

A portable mobile communication apparatus (e.g., mobile device) may enable a user to make a payment using one or more of several different payment modes. The types of payment modes include Quick Response (QR) code payment, near field communication (NFC) payment, online payment (e.g., network payment), bill payment, payment via alias (e.g., telephone number, email address, or the like), or the like. The present invention enables a user to access the various payment modes via a single user interface. Therefore, when the user initiates an application (e.g., a payment application, a banking application for the user's banking account, or the like) on a mobile device (or when an application is automatically initiated based on a triggering event such as the user entering a merchant's premises), the user may navigate to an interface that enables selection of a payment mode to make a payment.

The various payment modes described herein may be accessible from the user's account (e.g., financial institution account, merchant account, social networking account, mobile payment account, or the like). Therefore, a user may need to initiate an appropriate application (e.g., banking application, merchant application, social networking application, mobile payment application, or the like) and provide the user's authentication credentials in order to access the user interface for paying via multiple payment modes. Alternatively, the appropriate application may be automatically initiated based on a triggering event (e.g., the mobile device determines that the mobile device is located at a merchant's premises based on global positioning system (GPS) information associated with the mobile device's position or based on check-in information associated with a user's social networking account). As used herein, “checking-in” refers to a mobile device (or the user of the mobile device) updating the user's status (e.g., social network status) to indicate that the user is located at a merchant's premises when the mobile device enters the premises.

Each of the payment modes described herein may be used for making a payment at a receiving terminal (e.g., a payment terminal at a merchant, another user's mobile device, or the like) or for making a remote payment via a network (e.g., data network, telecommunication network, or the like). While each of the different payment modes may be presented on the same interface page, they may also be presented on different interface pages. As used herein, a payment mode may also be referred to as a payment option or payment mode option. As used herein, an interface page may be a single screen view of the mobile device user interface. The user may view the interface page on the mobile device display with or without scrolling the interface page at least one of horizontally or vertically.

A user may have multiple payment cards associated with the user's account. In order to associate a payment card with the account, the user may manually input information associated with each card or capture an image of each card and upload the card to the account. Additionally, a user may select a default payment card. Additionally, the user may register or specify payment modes for each card. For example, a user may register a first payment card to be associated with a first payment mode, but not a second payment mode. As a further example, the user may register a second payment card to be associated with both a first payment mode and a second payment mode. As used herein, a payment card may comprise at least one of a debit card, a credit card, a gift card, a prepaid card, a merchant account, a financial institution account, or the like. Therefore, a payment card, as used herein, may refer to any source of funds. Additionally, the user may select whether the account automatically selects a payment card (e.g., a default payment card) upon selection of a payment mode option. If the user does not make this selection, the mobile device enables the user to select a desired payment card upon selection of the payment mode option.

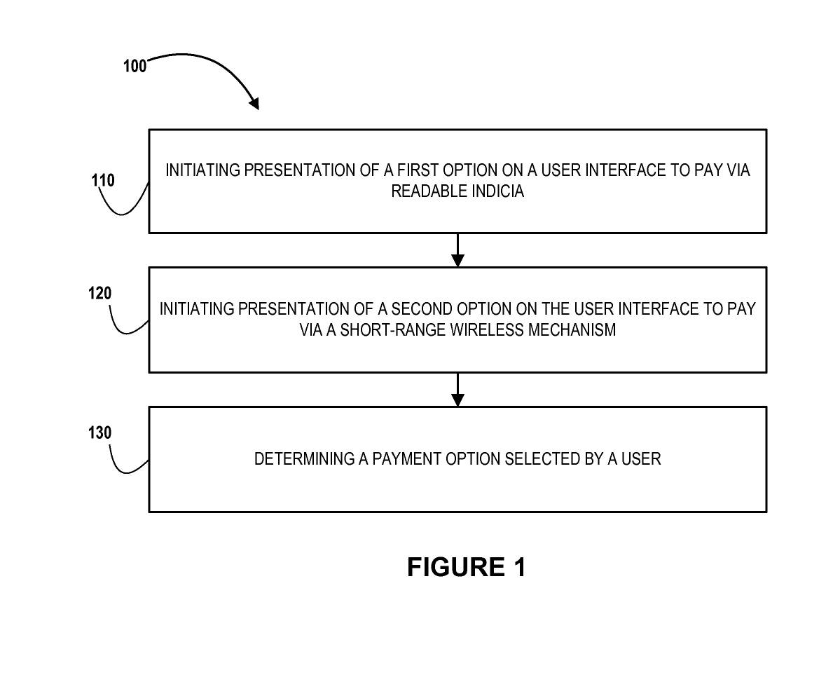

Referring now to FIG. 1, a general process flow 100 is provided for making a payment using a mobile device. At block 110, the method comprises initiating presentation of a first option on a user interface to pay via readable indicia. At block 120, the method comprises initiating presentation of a second option on the user interface to pay via a short-range wireless mechanism. At block 130, the method comprises determining a payment option (e.g., a first option, a second option, or the like) selected by a user. The portable mobile communication apparatus may also be referred to as a mobile device. In some embodiments, the various features and/or processes described herein may be executed by a non-mobile computing device. A user interface of a mobile device is presented on a display of the mobile device or on an external display in communication with the mobile device. Therefore, the present invention enables an NFC payment mode and a QR code payment mode to co-exist on the same mobile device and enables a user to select either payment mode from a single user interface.

The first payment option presented on the user interface may be payment via a short-range wireless mechanism (e.g., NFC transmission, short-range RF (radio frequency) transmission, or the like). This payment option may be used when the distance between the mobile device and the receiving terminal is a short distance (e.g., less than or equal to 25 cm). In response to determining the first option is selected by the user, the mobile device enables selection of a payment card from a list of payment cards presented on the user interface. Alternatively, in response to determining the first option is selected, the mobile device automatically selects a default payment card associated with this payment option. The payment cards (along with a default payment card) may have been previously registered by the user for use with this payment option. Optionally, the user may specify a payment amount.

Information associated with the payment cards may be stored on the mobile device (e.g., a secure module or secure element in the mobile device) or may be stored on a remote server accessible, via a network, by the mobile device. Therefore, in some embodiments, the selection of the first option triggers engagement with the secure module that comprises information (e.g., encrypted information) associated with the payment cards. The secure module may be part of a mobile wallet chip located in the mobile device. The selection of the first option (or selection of a payment card) additionally triggers activation of a transceiver for communicating information associated with the selected payment card (and optionally the specified payment amount) to a receiving terminal (e.g., another user's mobile device, a payment terminal at a merchant, or the like). The receiving terminal then initiates processing of the payment based on the selected payment card (and/or payment amount). In alternate embodiments, the first payment option may enable payment via a long-range wireless mechanism (e.g., greater than 25 cm such as longer-range RF transmission) instead of a short-range wireless mechanism. In such embodiments, the mobile device communicates information associated with the selected payment card (and optionally the specified payment amount) to a receiving terminal via a long-range wireless mechanism. The transceiver may either comprise at least one of an active (e.g., powered by a power source located in the mobile device) or a passive transceiver (e.g., powered by a power source located outside the mobile device such as an electromagnetic field generated by the receiving terminal). Additionally, the mobile device may encrypt the payment information prior to transmitting the information to the receiving terminal.

The invention is not limited to any particular protocol associated with wirelessly transmitting or receiving information between the mobile device and the receiving terminal. Additionally, the invention is not limited to any particular band of the electromagnetic spectrum associated with wirelessly transmitting or receiving information between the mobile device and the receiving terminal. Examples of short-range or long-range wireless communication mechanisms include near-field communication (NFC), short-range or long-range radio frequency (RF) signals, infra-red transmission (IR), Bluetooth, IEEE 802.11x, WiFi, or the like. The invention is not limited to any wireless mechanisms described herein.

The second payment option presented on the user interface may be payment via readable indicia. In some embodiments, the mobile device comprises an image-capturing component (e.g., a camera). In response to determining the second payment option is selected, the module is configured to activate the camera. The user may then focus the camera on readable indicia. The readable indicia may be presented on or near a payment terminal, on or near a product, on a check, bill, or invoice, on a display, or the like. The readable indicia may comprise any indicia, visual or non-visual, where information associated with the indicia is receivable or readable (e.g., capturable, scannable, or the like) by a mobile device. The readable indicia may comprise visual indicia, e.g., a barcode, a Quick Response (QR) code, or the like. The readable indicia may comprise any one-dimensional or two-dimensional code. The readable indicia may be static (e.g., a sticker) or dynamic (e.g., presented on a display such that the readable indicia changes from time to time). Therefore, the readable indicia may be physical indicia or electronic indicia.

Once the readable indicia is received, the mobile device processes the readable indicia to initiate an application for making a payment. The application may comprise a banking application associated with the user's financial institution account. Alternatively, the application may comprise a merchant application associated with the user's merchant account. Alternatively, the application may comprise a social networking application associated with the user's social networking account. Alternatively, the application may comprise a mobile payment application associated with the user's mobile payment account. In some embodiments, the user may need to manually initiate the appropriate application. Additionally, the user may need to input authentication credentials to authenticate to the application and/or the account.

Upon initiation of the application, a user may select a payment card from a list of payment cards presented on the user interface. Alternatively, the mobile device may be configured to automatically select a default payment card associated with this payment option. The payment cards (along with a default payment card) may have been previously registered by the user for use with this payment option. Additionally, the user may input a payment amount. Alternatively, the payment amount may be automatically generated based on information extracted from the readable indicia. The user may then select an option to make the payment (e.g., transmit information associated with the payment card and/or payment amount along a payment processing path via a network).

In some embodiments, rather than receiving readable indicia at the mobile device, the mobile device may present or generate readable indicia on the mobile device, wherein a receiving terminal may receive (e.g., capture an image of, scan, or the like) the readable indicia from the mobile device. The readable indicia presented on the mobile device may be based on the identity of the recipient. For example, if the recipient is a merchant, the readable indicia is associated with the user's merchant account or the user's merchant card or the user's prepaid card for making purchases at the merchant. The user may associate the user's merchant account (or merchant card or prepaid card) with the user's financial institution account so that the banking application on the mobile device may present the readable indicia associated with the user's merchant account (or merchant card or prepaid card). In alternate embodiments, the readable indicia is presented by another application such as a merchant application, a social networking application, a mobile payment application, or the like. As a further example, the presented or generated readable indicia may be generic readable indicia not associated with a particular recipient. For example, when the user of the mobile device wants to send a payment to another user, the mobile may generate generic readable indicia (e.g., one-time use readable indicia).

Therefore, when the user selects the second option to pay via readable indicia (or when the user selects an alternate readable indicia option), the mobile device may present readable indicia (e.g., a QR code) on the mobile device display. In some embodiments, the user may select a recipient from a list of recipients so that the mobile device presents the readable indicia associated with the selected recipient (e.g., a merchant, another user, or the like). In other embodiments, the mobile device may automatically present the readable indicia associated with a particular recipient (e.g., a merchant) based on determining the location of the user's mobile device (e.g., based on global positioning system (GPS) information associated with the user's mobile device indicating the user is located at the merchant's premises, or based on check-information associated with the user's social networking account indicating the user is located at the merchant's premises, or the like). In some embodiments, the mobile device may dynamically generate readable indicia (e.g., one-time use readable indicia) upon the user's selection of the option to pay via readable indicia such that the readable indicia generated on one occasion may be different from the readable indicia generated on another occasion. In other embodiments, the readable indicia associated with a particular recipient remains static (e.g., does not change from one occasion to another occasion).

The user may subsequently allow a receiving terminal (which may include a camera) to capture an image of the readable indicia presented on the user's mobile device. When the receiving terminal captures the image, the receiving terminal may process the received readable indicia to determine that the readable indicia is associated with particular identification information (e.g., a particular user, a particular alias (a phone number, email address, a social networking account, or a financial institution account associated with the user), or a particular account associated with the user (e.g., a merchant account associated with the user). The receiving terminal (or a system in communication with the receiving terminal) may subsequently access a database to determine a payment card (e.g., a default payment card) associated with the particular identification information. The receiving terminal may then initiate processing of the payment by transmitting at least one of the determined payment card information, the payment amount information, and optionally the identification information along a payment processing path via a network.

The third payment option presented on the user interface may be payment via alias. When the user selects the third option, the user interface may prompt the user to input at least one of an alias (e.g., a recipient or destination alias), a payment card, and a payment amount. The alias comprises at least one of a phone number, email address, a social networking account, or a financial institution account. The user may input an alias to which the payment will be made (e.g., funds will be transmitted). Alternatively, the user may select from one of previously used destination aliases (e.g., if the user previously made payments to those aliases). In some embodiments, the user may need to register a destination alias as a potential destination for sending payments prior to sending a payment to the destination alias. Additionally, the user may select a payment card from a list of payment cards presented on the user interface. Alternatively, the mobile device may be configured to automatically select a default payment card associated with this payment option. The payment cards (along with a default payment card) may have been previously registered by the user for use with this payment option. Additionally, the user may input a payment amount. The user may then select an option to make a payment to the selected alias (e.g., information associated with the alias, the payment card, and the payment amount may be transmitted along a payment processing path via a network). A processing system receives the alias, and accesses a database or repository to determine whether the alias is associated with an account (e.g., a financial institution account). If the alias is associated with an account, the system initiates transmission of the payment to the identified account. On the contrary, if the alias is not associated with an account (e.g., the recipient has not registered the recipient's account to receive payment via alias), the payment is returned to the sender (e.g., the user of the mobile device). Additionally, an invitation may be sent to the recipient to register the recipient's account in order to receive future payments via alias.

The fourth payment option presented on the user interface may be payment via network (e.g., a public network such as the Internet, a private network, wide area network, a local area network, a telecommunication network, a data network, or the like). When the user selects the fourth option, the user interface may prompt the user to input or select at least one of a destination account (e.g., a financial institution account), a payment card, and a payment amount. The destination account may be an account that has been previously registered as a destination account for sending payments from the user's account (e.g., the user may have previously transmitted a payment to the destination account). Alternatively, the user may input information associated with a new destination account (or register a new destination account). Additionally, the user may select a payment card from a list of payment cards presented on the user interface. Alternatively, the mobile device may be configured to automatically select a default payment card associated with this payment option. The payment cards (along with a default payment card) may have been previously registered by the user for use with this payment option. Additionally, the user may input a payment amount. The user may then select an option to make a payment to the selected destination account (e.g., information associated with the destination account, the payment card, and the payment amount may be transmitted along a payment processing path via a network).

The fifth payment option presented on the user interface may be a bill payment option. When the user selects the fifth option, the user interface may prompt the user to input or select at least one of a bill (e.g., a bill associated with the user's account), a payment card, a bill payment date, and a payment amount. The bill may be a bill that has been previously registered by the user to be associated with the user's account (e.g., the user may have previously paid the bill from the user's financial institution account). Alternatively, the user may input information associated with a new bill. In order to associate a new bill with the user's account, the user may select a merchant associated with the bill and may input a bill or invoice number or the account number associated with the user's merchant account (e.g., utilities account). Additionally, the user may select a payment card from a list of payment cards presented on the user interface. Alternatively, the mobile device may be configured to automatically select a default payment card associated with this payment option. The payment cards (along with a default payment card) may have been previously registered by the user for use with this payment option. Additionally, the user may input a payment date and an amount of payment to be made on the selected payment date. Alternatively, the payment amount (and/or the payment date) may be automatically populated based on the bill amount (e.g., the payment amount may be equal to the bill amount, the payment date may be the due date of the bill, or the like). The user may then select an option to make the bill payment (e.g., information associated with the bill, the payment card, and the payment amount may be transmitted along a payment processing path via a network).

Regardless of the payment option selected by the user, a receipt confirming the payment is transmitted to or presented on the user's mobile device. Receipts associated with payments (which may be associated with different payment modes) are stored together on the mobile device or at a remote server accessible by the mobile device. Therefore, a user may authenticate to the user's account and access a ‘Receipts’ area to view receipts associated with payments executed from the user's mobile device (e.g., payments via NFC, QR code, or the like).

In some embodiments, the mobile device may obtain location information associated with the mobile device based on processes described herein (e.g., based on GPS information associated with the mobile device, check-in information associated with the mobile device or user's social networking account, or the like). The mobile device may determine that the mobile device is located at the premises of a particular merchant. The mobile device may access information associated with the merchant to determine that the merchant will enable the user to pay via a first payment option, but will not enable the user to pay via a second payment option. Based on this information, the mobile device will present the first payment option on the user interface, but will not present the second payment option on the user interface. If the mobile device cannot determine a particular location of the mobile device or if the mobile device determines that the mobile device is not at a merchant's premises (e.g., the mobile device is in the user's house), the mobile device will present all possible payment options on the user interface.

In some embodiments, rather than the user selecting a payment option, the mobile device may automatically select a payment option based on pre-configured preferences established by the user. For example, the user may associate a first payment option with a first merchant. Therefore, if the mobile device determines, based on location information associated with the mobile device, that the mobile device is located at the first merchant, the mobile device may automatically select the first payment option.

In some embodiments, rather than enabling a user to select a payment card upon selection of the payment option, the mobile device may enable the user to initially select a payment card (and/or define a payment amount). The mobile device may subsequently enable a user to select a payment option in order communicate information associated with the selected payment card (and/or the payment amount) to a recipient (e.g., a receiving terminal via NFC, a recipient via alias, or the like).

In some embodiments, a user enters the premises associated with a merchant. The mobile device determines that the user has entered the premises of the merchant based on location information associated with the mobile device as described herein. The mobile device identifies the merchant based on the location information associated with the mobile device. The mobile device then accesses a remote database (e.g., via a network connection) associated with the merchant to determine the types of payment options (e.g., payment via readable indicia, payment via short-range wireless mechanism, or the like) that are accepted by the merchant. When the user initiates an application to reach a payment interface page or when the application is automatically initiated by the mobile device, the user interface presents only those payment options that are accepted by the merchant. Alternatively, when the user initiates an application to reach a payment interface page or when the application is automatically initiated by the mobile device, the user interface presents all possible payment options, but the payment options that are not accepted by the merchant cannot be selected by the user (e.g., those payment options are presented but they may be crossed out or greyed out). This indicates to the user that the merchant does not accept those payment options.

In some embodiments, a user enters the premises associated with a merchant. The mobile device determines that the user has entered the premises of the merchant based on location information associated with the mobile device as described herein. The mobile device identifies the merchant based on the location information associated with the mobile device. The mobile device then accesses a payment history of the user associated with transactions executed at the merchant's premises to determine the payment option selected by the user on the previous occasion when the user executed a transaction at the merchant's premises (or the payment option most frequently selected by the user when executing transactions at the merchant's premises during a predetermined period of time in the past). The payment history may be stored on the mobile device or at remote database accessible via a network connection. When the user initiates an application to reach a payment interface page or when the application is automatically initiated by the mobile device, the user interface automatically presents the payment option selected by the user on the previous occasion when the user executed a transaction at the merchant's premises (or the payment option most frequently selected by the user for transactions executed at the merchant's premises during a predetermined period of time in the past). This payment option may be configured to be the default payment option. Therefore, the mobile wallet (or mobile payment application) associated with the user's mobile device is an intelligent mobile wallet that determines a payment option based on a user's previous payment history or transaction history associated with a particular merchant. Additionally, the user interface may present an option for the user to navigate to another user interface presenting other payment options accepted by the merchant if the user chooses to pay via a different payment option and does not want to pay via the default payment option.

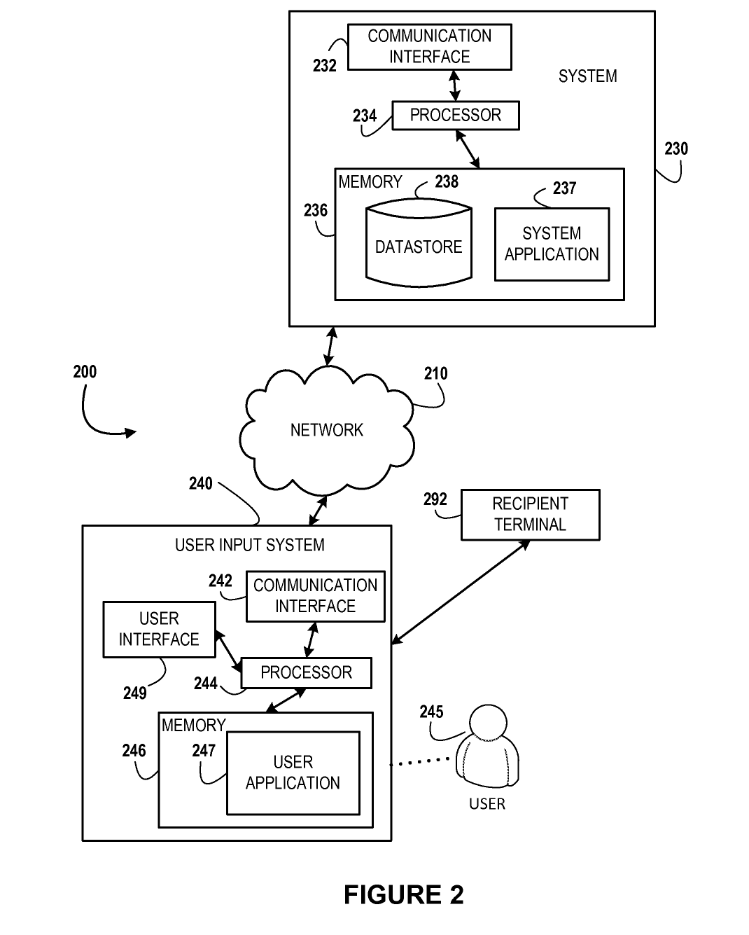

Referring now to FIG. 2, FIG. 2 presents an exemplary block diagram of the system environment 200 for implementing the process flow 100 described in FIG. 1, in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The system 230 may be an external server. The user application 247 and/or the system application 237 may incorporate one or more parts of the process flow 100 or any other function described herein. Therefore, the user input system 240 may be a mobile device as described herein. The system 230 may be a system in communication (e.g., network communication) with the user input system 240. The system 230 may manage the account described herein and provide the various payment modes described herein. Additionally, the 230 system may initiate processing of payments described herein. As described herein, any process described as being performed by the user input system 240 may be performed by at least one of the user input system 240 or the system 230. As described herein, any process described as being performed by the system 230 may be performed by at least one of the user input system 240 or the system 230.

In some embodiments, the user input system 240 communicates payment information to a recipient terminal 292. The recipient terminal 292 may be a payment terminal or another user's mobile device. The recipient terminal 292 may communicate with another system to initiate processing of a payment (e.g., payment information received from the user input system 240).

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230 or the recipient terminal 292. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to the recipient terminal 292 and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230 or the recipient terminal 292. The wireless transceiver may include a radio circuit to enable wireless transmission and reception of information. The wireless transceiver comprises an antenna. Therefore, the user input system 240 or the communication interface 242 includes an antenna for short-range or long-range wireless communication (e.g., reception and transmission of information) with the recipient terminal 292.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. The memory 246 may also comprise the secure module (e.g., comprising information associated with one or more payment cards) described herein. Alternatively, the secure module may be stored (e.g., in a mobile wallet chip) in the user input system 240 separately from the memory 246.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein.

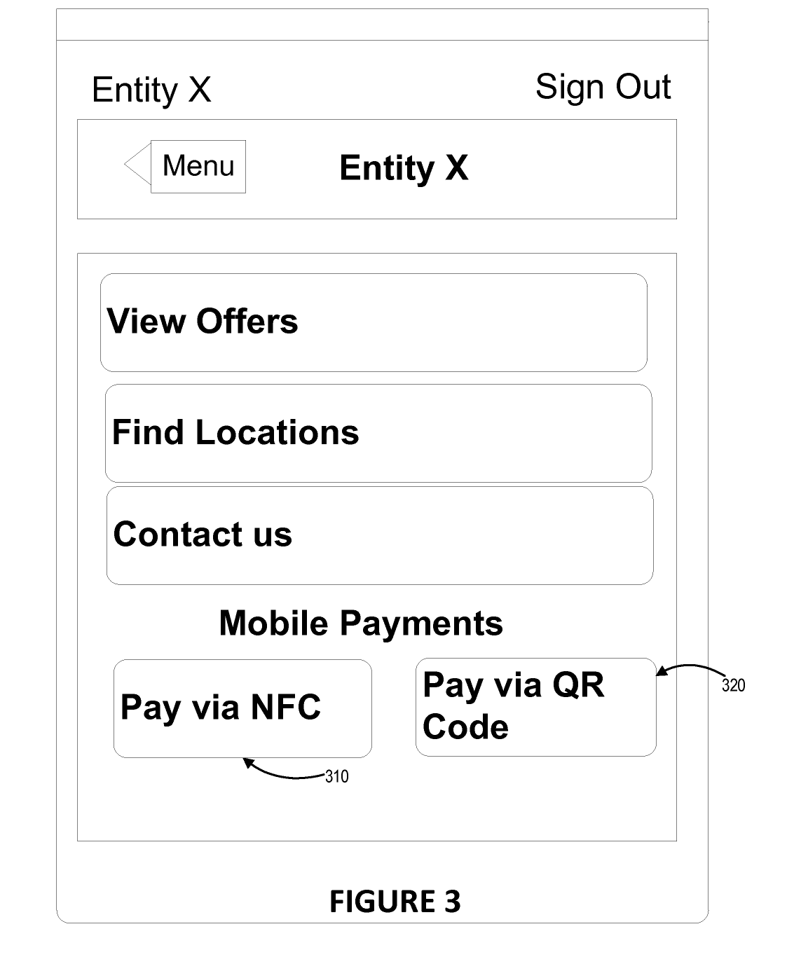

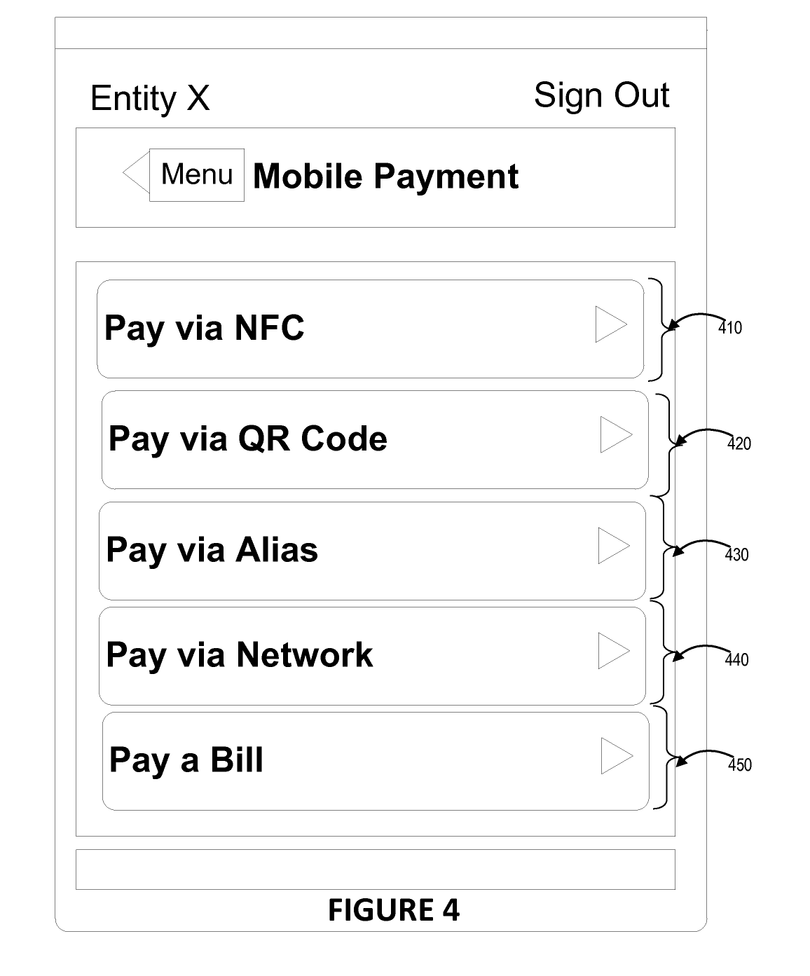

Referring now to FIGS. 3-10, FIGS. 3-10 present exemplary user interfaces for a making a payment, in accordance with embodiments of the invention. As indicated in FIG. 3, the user may select to pay via NFC 310 or pay via QR code 320 from the same user interface. As indicated in FIG. 3, the user interface may additionally present offers (e.g., rebate offers for purchases), locations associated with Entity X (e.g., a financial institution), and an option to contact the financial institution. As indicated in FIG. 3, the various options may be presented after the user authenticates to the user's account. As indicated in FIG. 4, the user may select to pay via NFC 410, pay via QR code 420, pay via alias 430, pay via network 440, or pay a bill 450 from the same user interface.

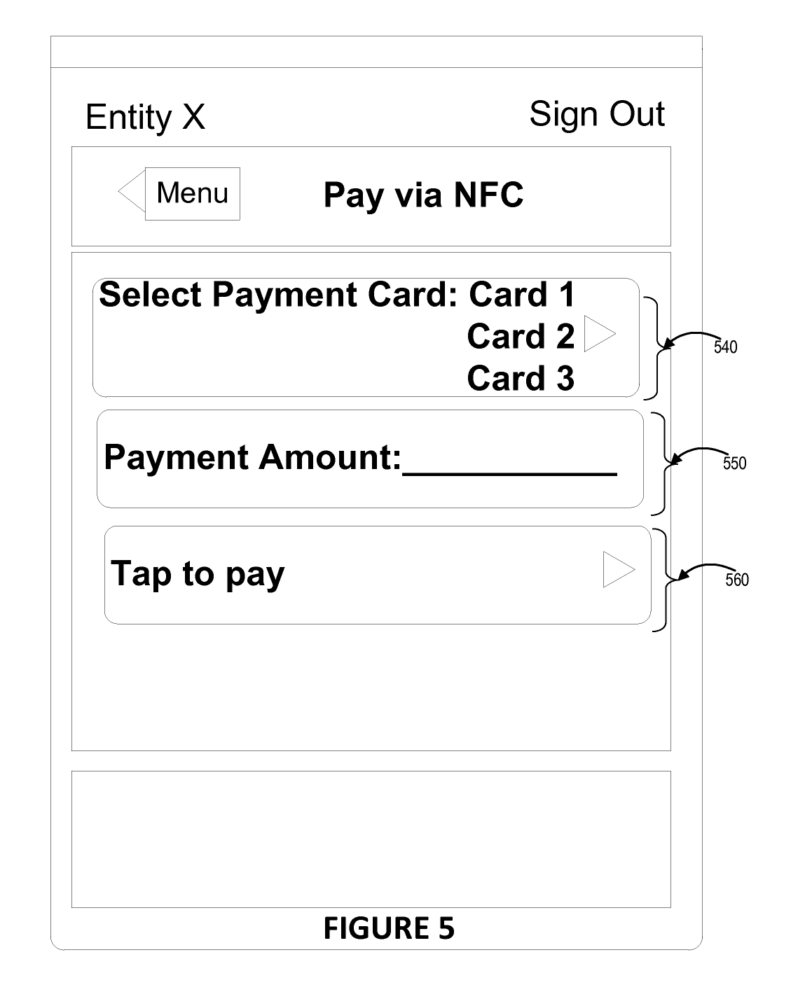

If the user selects to pay via NFC, the user is presented with the user interface of FIG. 5. The user may select a payment card 540 (e.g., Card 2) unless a default payment card has been automatically selected, enter a payment amount 550 (unless the payment amount has been automatically populated), and click (e.g., touch or tap with the user's finger) to make the payment 560.

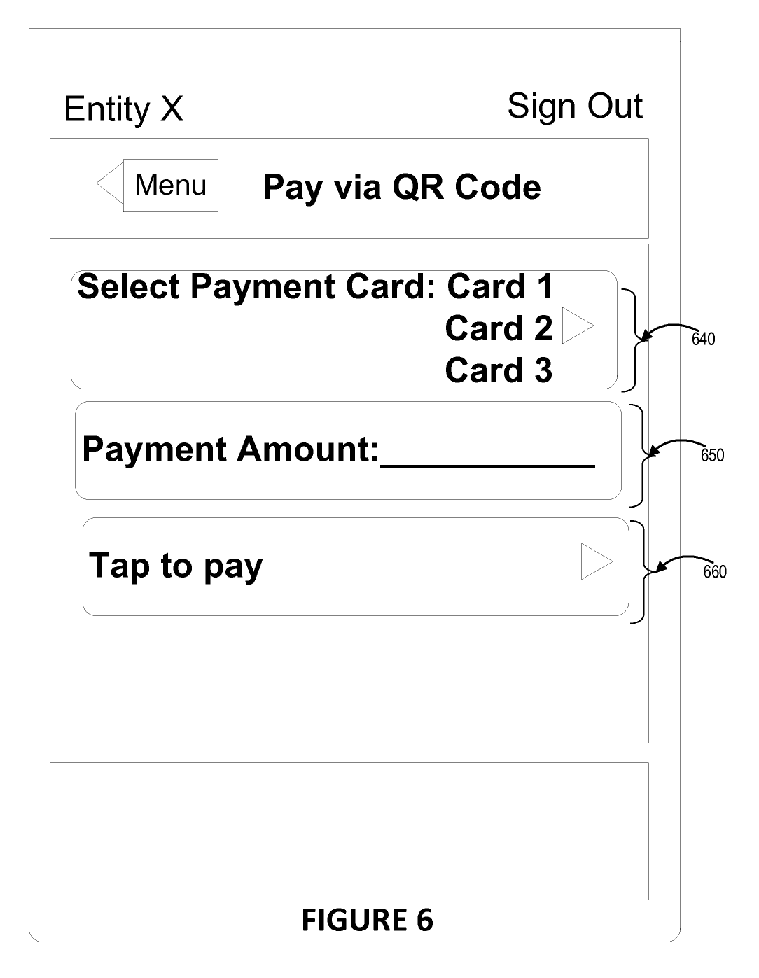

If the user selects to pay via QR code, the user is presented with the user interface of FIG. 6 upon capturing an image of a QR code. The user may select a payment card 640 (e.g., Card 2) unless a default payment card has been automatically selected, enter a payment amount 650 (unless the payment amount has been automatically populated), and click to make the payment 660. For each of the user interfaces presented herein, immediately after (or a predetermined period after) the user clicks to make the payment, the user may be presented with confirmation that the payment has been made.

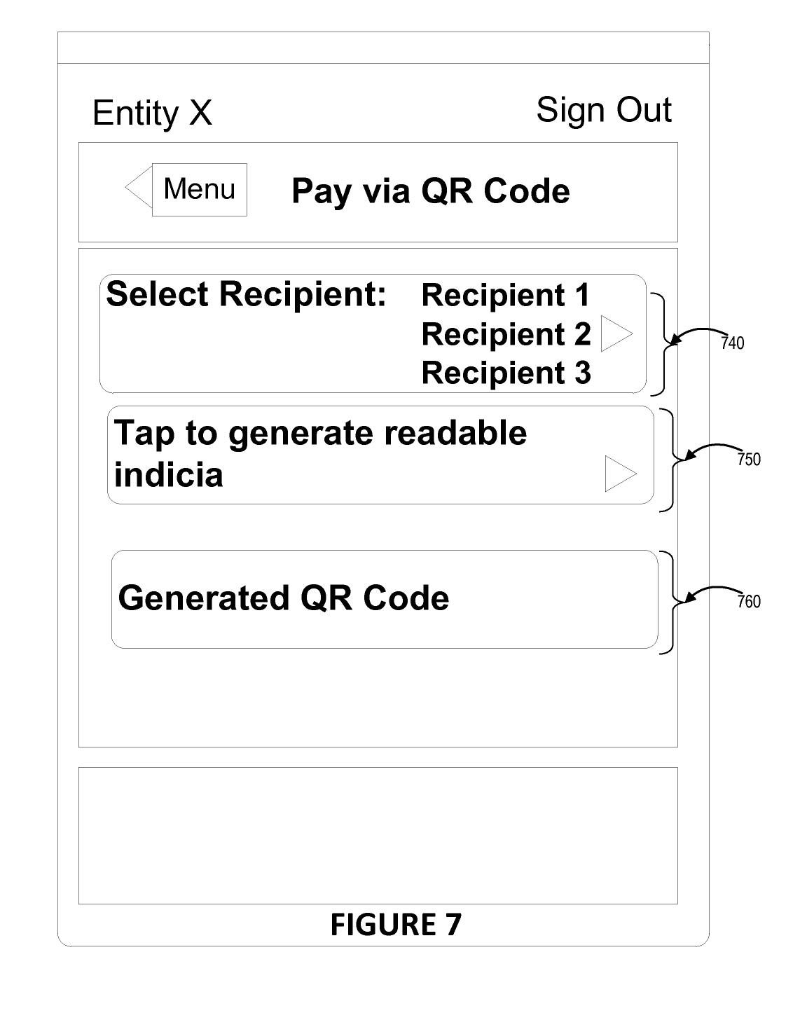

In alternate embodiments, if the user selects to pay via QR code, the user is presented with the user interface of FIG. 7. The user may select a recipient 740 (e.g., Recipient 2) unless the mobile device automatically determines the recipient, and the user may then select an option to generate readable indicia 750. The readable indicia may be presented on the same user interface 760 or on a different user interface.

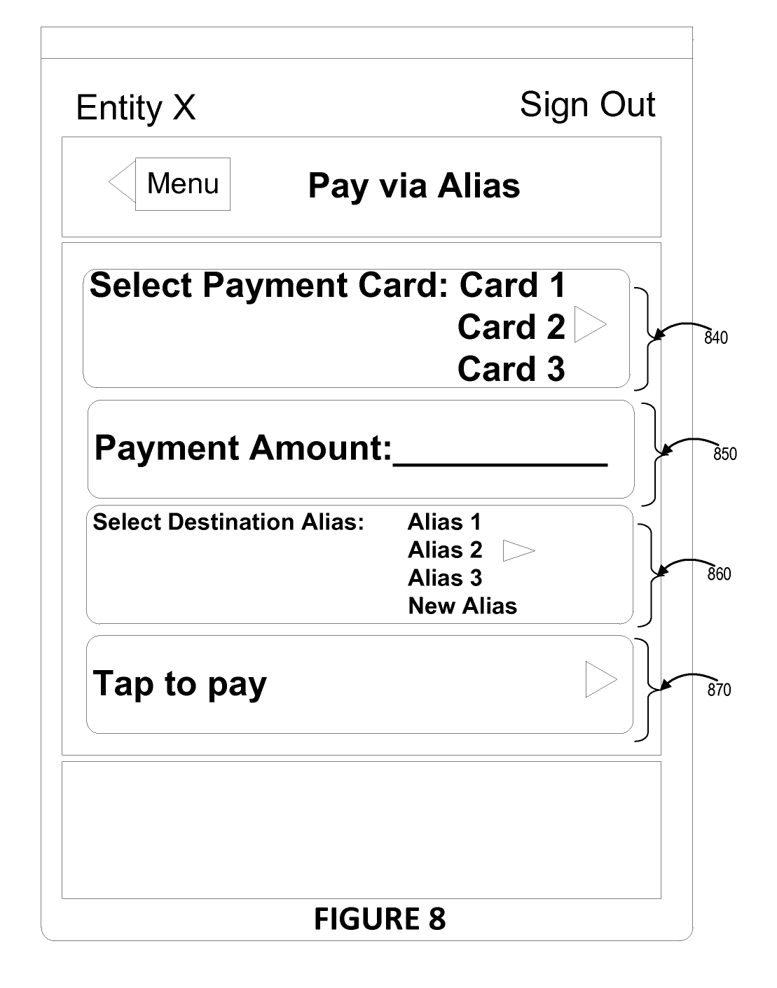

If the user selects to pay via alias, the user is presented with the user interface of FIG. 8. The user may select a payment card 840 (e.g., Card 2) unless a default payment card has been automatically selected, enter a payment amount 850 (unless the payment amount has been automatically populated), select a destination alias (e.g., alias 2) 860 (or create a new destination alias), and click to make the payment 870.

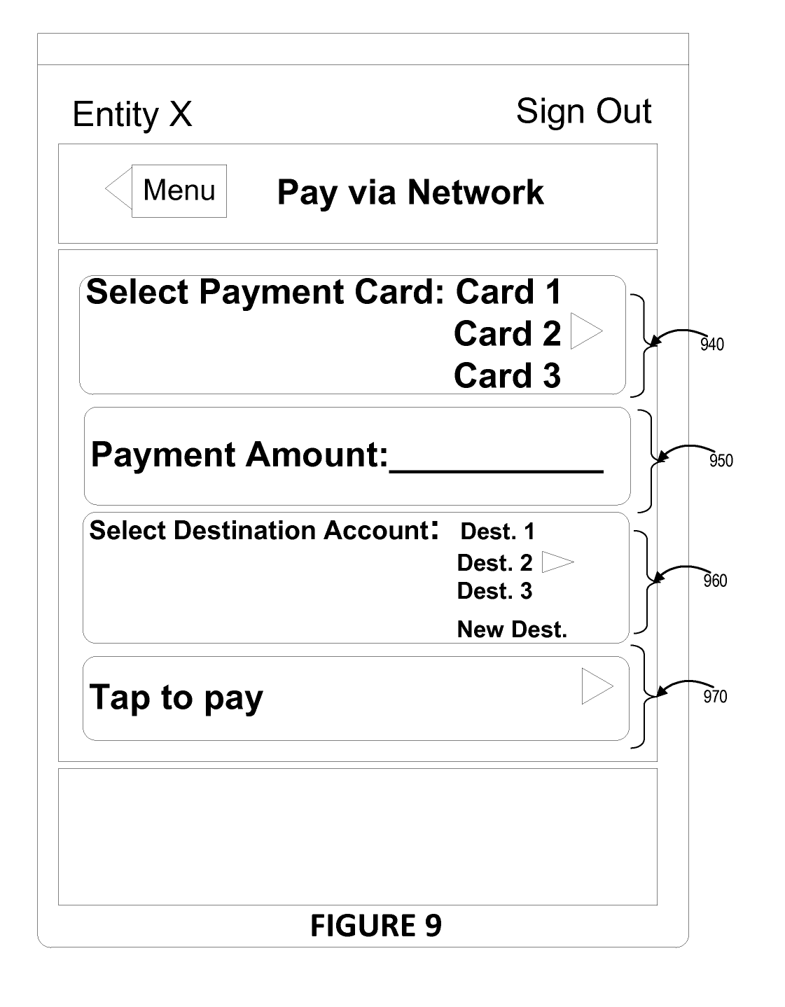

If the user selects to pay via network, the user is presented with the user interface of FIG. 9. The user may select a payment card 940 (e.g., Card 2) unless a default payment card has been automatically selected, enter a payment amount 950 (unless the payment amount has been automatically populated), select a destination account (e.g., destination account 2) 960 (or associate new destination account with the user's account), and click to make the payment 970.

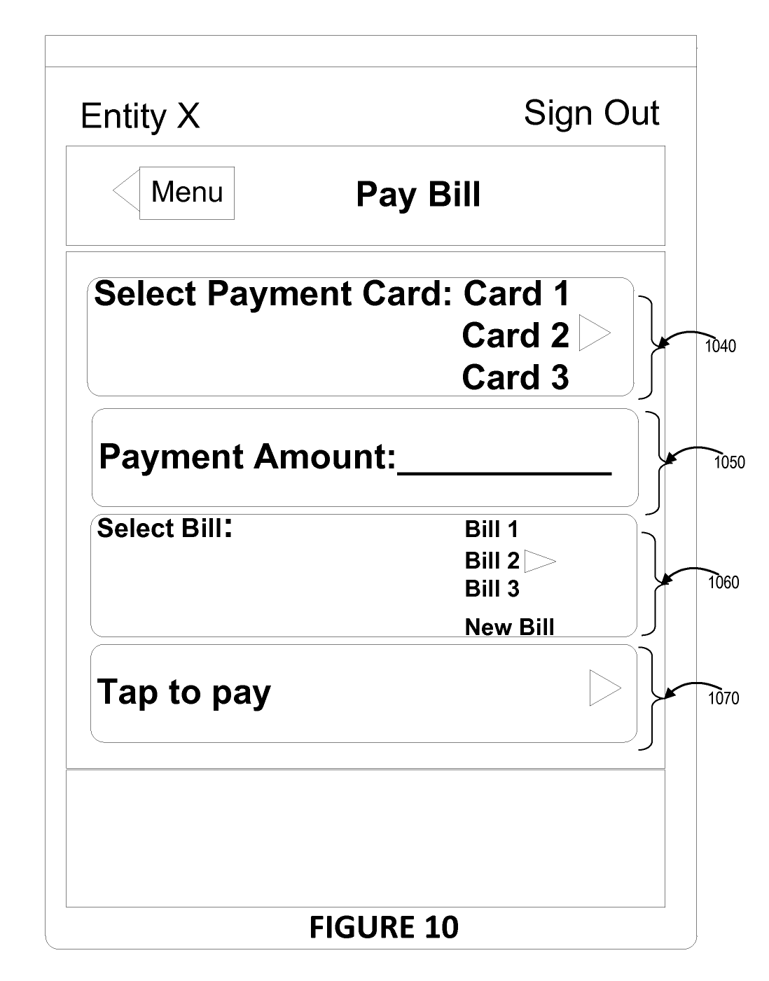

If the user selects to pay a bill, the user is presented with the user interface of FIG. 10. The user may select a payment card 1040 (e.g., Card 2) unless a default payment card has been automatically selected, enter a payment amount 1050 (unless the payment amount has been automatically populated), select a bill (e.g., bill 2) 1060 (or associate new bill with the user's account), and click to make the payment 1070.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the financial institution may allow a user to establish an account with the financial institution. An “account” may be the relationship that the user has with the financial institution. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the financial institution.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software. As used herein, the phrase “based on” may be used interchangeably with the term “comprising.”

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A portable mobile communication apparatus for making a payment, the apparatus comprising:
a memory;
a processor; and
a computing module stored in the memory, executable by the processor, and configured to:
initiate presentation of a first option on a user interface to pay via readable indicia at a point-of-sale terminal, wherein the first option enables capture of the readable indicia at the point-of-sale terminal using the portable mobile communication apparatus, wherein the readable indicia is not generated by the portable mobile communication apparatus;
initiate presentation of a second option on the user interface to pay via a short-range wireless mechanism at the point-of-sale terminal, wherein the second option enables transmission of data from the portable mobile communication apparatus to the point-of-sale terminal; and
determine a payment option selected by a user.

2. The apparatus of claim 1, wherein in response to determining the first option is selected by the user, the module is configured to enable selection of a payment card from a list of payment cards presented on the user interface or automatically select a default payment card.

3. The apparatus of claim 1, wherein in response to determining the first option is selected, the module is configured to activate a transceiver for communicating information associated with a selected payment card.

4. The apparatus of claim 1, wherein a transceiver for making a payment via the short-range wireless mechanism is an active transceiver or a passive transceiver, wherein information associated with one or more payment cards is stored in a secure module in the apparatus or at a remote server accessible by the apparatus.

5. The apparatus of claim 1, wherein the short-range wireless mechanism comprises near-field communication (NFC).

6. The apparatus of claim 1, wherein the apparatus comprises an image-capturing component, wherein in response to determining the second option is selected, the module is configured to activate the image-capturing component to capture an image of the readable indicia, wherein the readable indicia comprises at least one of electronic readable indicia or physical readable indicia, wherein the module is further configured to process the readable indicia, wherein processing the readable indicia comprises at least one of initiating presentation of a user interface that prompts the user to select a payment card, or automatically selecting a default payment card.

7. The apparatus of claim 1, wherein the first option does not enable transmission of data from the portable mobile communication apparatus to the point-of-sale terminal.

8. (canceled)

9. The apparatus of claim 1, wherein the readable indicia comprises a Quick Response (QR) code.

10. The apparatus of claim 1, wherein the module is further configured to initiate presentation of a third option on the user interface to pay via alias, wherein in response to determining the third option is selected, the module is configured to enable the user to input a payment amount and an alias associated with a payment recipient, wherein the alias comprises at least one of a phone number, email address, social networking account information, or financial institution account information.

11. The apparatus of claim 1, wherein the module is further configured to initiate presentation of a fourth option on the user interface to pay via a network.

12. The apparatus of claim 1, wherein the module is further configured to initiate presentation of a fifth option on the user interface to make a bill payment, wherein in response to determining the fifth option is selected, the module enables selection of a bill associated with the user's account, and at least one of a payment card associated with the account, a payment date on which the bill payment will be made, or an amount of the bill payment on the selected payment date.

13. The apparatus of claim 1, wherein the first option and the second option are accessible via the user's account, wherein the account comprises at least one of a financial institution account, a merchant account, a social networking account, or a mobile payment account.

14. The apparatus of claim 1, wherein receipts associated with executed payments are stored in the apparatus or stored at an external server, wherein the receipts comprise a first receipt associated with a payment made via the readable indicia and a second receipt associated with a payment made via the short-range wireless mechanism.

15. The apparatus of claim 1, wherein the module, based on location information associated with the apparatus, initiates presentation on the user interface of a payment option available to the user, and wherein the module does not initiate presentation on the user interface of a payment option unavailable to the user, wherein a payment option available to the user comprises a payment option accepted by a merchant corresponding to the location information associated with the apparatus.

16. The apparatus of claim 1, wherein the module, based on location information associated with the apparatus, initiates presentation on the user interface of a payment option available to the user, and wherein the module initiates presentation on the user interface of a payment option unavailable to the user, wherein the module does not enable the user to select the payment option unavailable to the user, wherein a payment option available to the user comprises a payment option accepted by a merchant corresponding to the location information associated with the apparatus.

17. The apparatus of claim 1, wherein the module is configured to initiate a default payment option on the user interface, wherein the default payment option comprises a payment option based on a payment history associated with the user, wherein the payment history is associated with at least one transaction executed by the user associated with a merchant corresponding to location information associated with the apparatus.

18. The apparatus of claim 1, wherein the module is configured to initiate a default payment option on the user interface, wherein the default payment option comprises a payment option selected by the user on a previous occasion when the user executed a transaction associated with a merchant corresponding to location information associated with the apparatus, or wherein the default payment option comprises a payment option most frequently selected by the user during a predetermined period of time when the user executed at least one transaction associated with a merchant corresponding to location information associated with the apparatus, and wherein the module enables the user to select a payment option different from the default payment option.

19. A method for making a payment using a portable mobile communication apparatus, the method comprising:
initiating, using a computing device processor located in the portable mobile communication apparatus, presentation of a first option on a user interface to pay via readable indicia at a point-of-sale terminal, wherein the first option enables capture of the readable indicia at the point-of-sale terminal using the portable mobile communication apparatus, wherein the readable indicia is not generated by the portable mobile communication apparatus;
initiating, using a computing device processor located in the portable mobile communication apparatus, presentation of a second option on the user interface to pay via a short-range wireless mechanism at the point-of-sale terminal, wherein the second option enables transmission of data from the portable mobile communication apparatus to the point-of-sale terminal; and
determining, using a computing device processor located in the portable mobile communication apparatus, a payment option selected by a user.

20. A computer program product for making a payment using a portable mobile communication apparatus, the computer program product comprising:
a non-transitory computer-readable storage medium comprising instructions configured to cause a portable mobile communication apparatus to:
initiate presentation of a first option on a user interface to pay via readable indicia at a point-of-sale terminal, wherein the first option enables capture of the readable indicia at the point-of-sale terminal using the portable mobile communication apparatus, wherein the readable indicia is not generated by the portable mobile communication apparatus;
initiate presentation of a second option on the user interface to pay via a short-range wireless mechanism at the point-of-sale terminal, wherein the second option enables transmission of data from the portable mobile communication apparatus to the point-of-sale terminal; and
determine a payment option selected by a user.
